(19) United States
(12) Patent Application Publication
(10) Pub. No.: US 2007/0072056 A1
(43) Pub. Date: Mar. 29, 2007

(54) Membrane electrode assembly and fuel cell system including the same

(75) Inventors: Jung-min Oh, Yongin-si (KR); Hae-kyoung Kim, Seoul (KR); Hyuk Chang, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/508,158

(22) Filed: Aug. 23, 2006

(30) Foreign Application Priority Data
Sep. 23, 2005 (KR) 2005-88716

(51) Int. Cl. H01M 4/94; H01M 8/10; H01M 4/96

(52) U.S. Cl. 429/44; 429/30; 429/42

(57) ABSTRACT

A membrane electrode assembly for a fuel cell, in which electrical resistance is minimized by including a current collector between a catalyst layer and a fuel diffusion layer inside electrodes to shorten the electron transfer distance, and in which corrosion of the current collector due to direct contact between the current collector and the catalyst in the catalyst layer is prevented by including an electrically conductive current collector-protecting layer between the current collector and the catalyst layer, and a fuel cell including the membrane electrode assembly which can stably exhibit constant performance for a prolonged period of time, and which has excellent efficiency due to low electrical resistance.

### CROSS-REFERENCE TO RELATED APPLICATION

This application claims the benefit of Korean Patent Application No. 2005-88716, filed on Sep. 23, 2005, in the Korean Intellectual Property Office, the disclosure of which is incorporated herein in its entirety by reference.

### BACKGROUND OF THE INVENTION

1. Field of the Invention

Aspects of the present invention relate to a membrane electrode assembly for a fuel cell and a fuel cell including the membrane electrode assembly. In particular, aspects of the present invention relate to a membrane electrode assembly for a fuel cell in which electrical resistance is minimized by disposing a current collector between the catalyst layer and the fuel diffusion layer of electrodes to shorten the electron transfer distance, and in which corrosion of the current collector due to direct contact between the current collector and the catalyst in the catalyst layer is prevented by disposing an electrically conductive current collector-protecting layer between the current collector and the catalyst layer, and a fuel cell including the membrane electrode assembly.

2. Description of the Related Art

The increase in popularity of portable electronic instruments and wireless communication instruments has resulted in increased interest in and on-going research on the development of power-generating fuel cells as portable power supplies and clean energy sources.

A fuel cell is a new type of power-generating system that directly converts electrochemical energy generated in a reaction between a fuel gas (such as, for example, hydrogen or methanol) and an oxidizing agent (such as, for example, oxygen or air) into electrical energy. Fuel cells are classified into phosphoric acid fuel cells, molten carbonate fuel cells, solid oxide fuel cells, polymeric electrolyte fuel cells and alkaline fuel cells according to the kind of electrolyte used. These fuel cells operate on essentially the same principle, but they are differentiated by the type of fuel used, the operating temperature, catalysts used, the electrolyte used, and so on.

Polymeric electrolyte fuel cells can be further classified into proton exchange membrane fuel cells (PEMFC), which use hydrogen gas as a fuel, direct methanol fuel cells (DMFC), which use liquid methanol and the like as a direct fuel supplied to the anode.

In particular, since a DMFC can operate at ambient temperatures and can be easily miniaturized with perfect sealing, this type of fuel cell can be used as a power source in various applications such as pollution-free electric automobiles, home generating systems, mobile communication instruments, medical instruments, military facilities, space facilities, portable electronic instruments and devices, and so on.

In a DMFC, a methanol oxidation reaction occurs at the anode, and protons and electrons thus generated migrate to the cathode. The protons that migrate to the cathode bind with oxygen, thus being oxidized, and an electromotive force generated by the oxidation of the protons functions as an energy source for the DMFC. The reactions that take place at the anode and the cathode in this process are as follows:
Anode: CH₃OH+H₂O→CO₂+6H⁺+6e⁻Eₐ=0.04 V
Cathode: 3/2O₂+6H⁺+6e⁻→3H₂O E_{c}=1.23 V
Overall Reaction: CH₃OH+3/2O₂→CO₂+2H₂O E_{cell}=1.19V

Aspects of the present invention relates to a membrane electrode assembly (MEA) in which electrical resistance is reduced when electrons generated at a catalyst layer migrate to a current collector, in which CO2 generated at the anode is efficiently removed and in which air is efficiently supplied to the cathode.

The MEA according to embodiments of the present invention is applicable to an active type fuel cell system, in which the feeding of fuel (methanol and air) necessitates external fuel feeding apparatuses such as pumps or compressors, as well as to a passive type fuel cell system, in which fuel is fed spontaneously without requiring any additional external transport apparatuses, and a semi-passive type fuel cell system, which is an intermediate between the active type and the passive type fuel cell systems. A fuel cell according to embodiments of the present invention can be used as a power source for small-sized portable electronic instruments and devices.

Fuel cell systems may also be classified into stack type fuel cell systems, in which a few to a few tens of unit cells are stacked, each of the unit cells consisting of an MEA, which is the substantial electricity-generating element, and a separator, which is also called a bipolar plate; and monopolar type fuel cell systems, in which a plurality of unit cells are connected in series on a single sheet of an electrolyte membrane. Fuel cells including monopolar type MEAs have significantly small thicknesses and volumes, and thus, monopolar type MEAs allow the production of small-sized DMFCs for portable use.

An MEA generally includes a polymeric electrolyte membrane sandwiched between an anode (also called the fuel electrode or oxidizing electrode) and a cathode (also called the air electrode or reducing electrode).

In detail, an electrolyte membrane is centered between two electrodes (the cathode and the anode). Each of the electrodes comprises a catalyst layer, a fuel diffusion layer and a support layer. In a conventional fuel cell, a current collector, which collects current generated at the electrode and transfers the current to an external circuit, is disposed at the outside of the support layer.

However, since the current collector is disposed apart from the catalyst layer and the diffusion layer, there is contact resistance between the current collector and the electrode, and electrons generated at the catalyst layer encounter resistance as the electrons migrate to the current collector via the fuel diffusion layer and support layer. This resistance contributes to fuel cell inefficiency.

Further, in order for the current generated at the catalyst layer to be transferred to the current collector, both the diffusion layer and the support layer must employ electrically conductive materials. The need for electrically conductive material for the diffusion layer and the support layer imposes a limitation on the selection of material for these layers. a Such a limitation is directly related to the limited performance of fuel cells, since non-conductive materials that could enhance the performance of fuel cells are excluded from consideration as materials for the diffusion layer and the support layer.

### SUMMARY OF THE INVENTION

Aspects of the present invention provide a membrane electrode assembly in which electrical resistance is minimized by disposing a current collector between a catalyst layer and a fuel diffusion layer inside electrodes to shorten the electron transfer distance, and in which corrosion of the current collector due to direct contact between the current collector and the catalyst in the catalyst layer is prevented or minimized by disposing an electrically conductive current collector-protecting layer between the current collector and the catalyst layer.

Aspects of the present invention also provide a fuel cell including the membrane electrode assembly.

According to an aspect of the present invention, there is provided an electrolyte membrane electrode assembly, including: an electrolyte membrane; an anodic catalyst layer and a cathodic catalyst layer disposed respectively on each side of the electrolyte membrane; an anodic current collector-protecting layer and a cathodic current collector-protecting layer disposed on the anodic catalyst layer and the cathodic catalyst layer, respectively; an anodic current collector and a cathodic current collector disposed on the anodic current collector-protecting layer and the cathodic current collector protecting layer, respectively; and an anodic fuel diffusion layer and a cathodic fuel diffusion layer disposed on the anodic current collector and the cathodic current collector, respectively.

According to another aspect of the present invention, there is provided an electrode of a membrane electrode assembly comprising a catalyst layer, a current collector protecting layer, a current collector, and a fuel diffusion layer, wherein the current collector-protecting layer is between the current collector and the catalyst layer and wherein the current collector and current collector-protecting layer are between the diffusion layer and the catalyst layer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a conventional membrane electrode assembly;

FIG. 2 is a cross-sectional view of a membrane electrode assembly according to an embodiment of the present invention;

FIG. 3 is a graph showing the results of a performance test for fuel cells of Examples 1 and 2 and Comparative Examples 1 and 2;

FIG. 4 is a graph showing the results of a performance test for the fuel cells of Example 1 and Comparative Example 1; and

FIG. 5 is a graph showing the results of a performance test for the fuel cells of Example 1 and Comparative Example 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

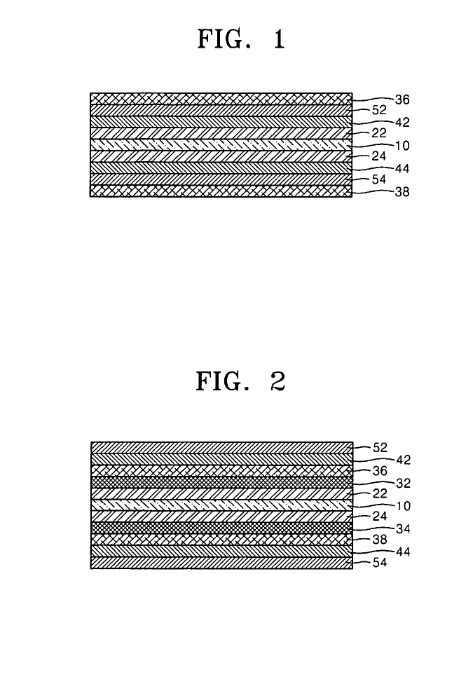

FIG. 1 is a cross-sectional view of a conventional membrane electrode assembly, and FIG. 2 is a cross-sectional view of a membrane electrode assembly according to an embodiment of the present invention.

The conventional membrane electrode assembly illustrated in FIG. 1 includes an electrolyte membrane 10 at its center, an anodic catalyst layer 22 disposed on one side of the electrolyte membrane and a cathodic catalyst layer 24 on the other side of the electrolyte membrane, and an anodic fuel diffusion layer 42 and a cathodic fuel diffusion layer 44 disposed on the anodic catalyst layer 22 and the cathodic catalyst layer 24, respectively. Further, an anodic layer 52 and a cathodic layer 54 are disposed on the anodic fuel diffusion layer 42 and the cathodic fuel diffusion layer 44, respectively, and an anodic current collector 36 and a cathodic current collector 38 are disposed on the anodic layer 52 and the cathodic layer 54, respectively.

Accordingly, in the conventional fuel cell, in order to allow the exchange of electric current between the electrodes 21 and 22 and the current collectors 36 and 38, the fuel diffusion layers 42 and 44 and the support layers 52 and 54 interposed therebetween must be electrically conductive. Electrons moving between the catalyst layers 22 and 24 and the current collectors 36 and 38, respectively, must pass through the fuel diffusion layers 42 and 44 and the layers 52 and 54, respectively, and therefore encounter significant electrical resistance.

Meanwhile, the membrane electrode assembly according to an embodiment of the present invention illustrated in FIG. 2 includes an electrolyte membrane 10 at its center, an anode catalyst layer 22 disposed on one side of the electrolyte membrane 10 and a cathodic catalyst layer 24 on the other side of the electrolyte membrane, and an anodic current collector-protecting layer 32 and a cathodic current collector-protecting layer 34 disposed on the anodic catalyst layer 22 and the cathodic catalyst layer 24, respectively. An anodic current collector 36 and a cathodic current collector 38 are disposed on the anodic current collector-protecting layer 32 and the cathodic current collector-protecting layer 34, respectively, and an anodic fuel diffusion layer 42 and a cathodic fuel diffusion layer 44 may be disposed on the anodic current collector 36 and the cathodic current collector 38, respectively.

In the paragraphs below, a common description is provided for the anode catalyst layer 22 and cathodic catalyst layer 24, the anodic current collector-protecting layer 32 and cathodic current collector-protecting layer 34, the anodic current collector 36 and cathodic current collector 38, the anodic fuel diffusion layer 42 and a cathodic fuel diffusion layer 44 and the anode support layer 52 and cathode support layer 54, and for convenience, these are referred to herein as simply the catalyst layer 22, 24, current collector-protecting layer 32, 34, current collector 36, 38, diffusion layer 42, 44 and support layer 52, 54. However, it is to be understood that the material compositions and physical features such as thickness, porosity and conductivity can be independently selected for the anode-side components or layers and the cathode-side components or layers.

In the membrane electrode assembly according to an embodiment of the present invention, the current collector-protecting layer 32, 34 formed between the catalyst layer 22, 24 and the current collector 36, 38 prevents corrosion of the current collector 36, 38 caused by direct contact between the catalyst layer 22, 24 and the current collector 36, 38, and also prevents physical damage to the catalyst layer 22, 24 caused by the current collector 36, 38 when the current collector 36, 38 is bonded to the catalyst layer 22, 24.

Furthermore, when current collector-protecting layers 32, 34 having excellent adherence to the current collector 36, 38 are used, electrical resistance caused by poor contact between the current collector 36, 38 and the catalyst layer 22, 24 can be reduced, and the current generated at the catalyst layer 22, 24 is collected in the current collector 36, 38 with minimal electrical resistance without passing through the fuel diffusion layer 42, 44.

In addition, the formation of fuel diffusion layer 42, 44 on the current collector 36, 38 allows the fuel diffusion layer 42, 44 to be formed of a wide range of materials, including conductive materials and non-conductive materials.

The current collector-protecting layer 32, 34 according to an embodiment of the present invention may be formed of any material showing electrical conductivity, such as, for example, a porous conductive material.

The material used for the current collector 32, 34 may be a carbonaceous material, possibly combined with an electrically conductive polymer or a conductive metal, but is not particularly limited thereto.

As non-limiting examples, the carbonaceous material may be selected from the group consisting of powdered carbon, graphite, carbon black, acetylene black, activated carbon, carbon nanotube, carbon nanofiber, carbon nanowire, carbon nanohorn, carbon nanoring and fullerene (C₆₀).

As non-limiting examples, the electrically conductive polymer may be polyaniline, polypyrrole, polythiophene or a mixture thereof.

The conductive metal may be a metal having a conductivity of 1 S/cm or greater, and, as non-limiting examples, may be gold (Au), silver (Ag), aluminum (Al), nickel (Ni), copper (Cu), platinum (Pt), titanium (Ti), manganese (Mn), zinc (Zn), iron (Fe), tin (Sn), or an alloy of these metals.

The current collector-protecting layer 32, 34 may comprise a porous material so as to serve as a support layer for the catalyst layer 22, 24, allow efficient delivery of fuel such as methanol, water and oxygen to the catalyst, and permit unimpeded discharge of products such as CO₂ and water out of the system.

The pores of the porous material may have an average diameter in the range of a few tens to a few hundreds of micrometers, which makes the transfer of fuel and products easy, and may have a porosity of 10% to 90%.

When the porosity is less than 10%, gaseous diffusion of the fuel may be unsatisfactory, or the discharge of generated CO₂ may be diminished. When the porosity is greater than 90%, the mechanical strength of the current collector-protecting layer may be too low.

The thickness of the current collector-protecting layer 32, 34 may be in the range of 10 μm to 500 μm. If the thickness of the current collector-protecting layer 32, 34 is less than 10 μm, the current collector-protecting layer 32, 24 would have insufficient mechanical strength, and thus the current collector 36, 38 and the catalyst layer 22, 24 would be incompletely separated. If the thickness of the current collector-protecting layer 32, 34 is greater than 500 μm, the electrical resistance would be too high, and the membrane electrode assembly would be excessively thick.

The current collector-protecting layer 32, 34 can be formed using a conventional process. For example, on a current collector-protecting layer 32, 34 having a porous structure as described above, a catalyst slurry may be coated by spraying or screen printing, and layers may be bonded to the catalyst slurry under high temperature and high pressure conditions, in an order of cathodic current collector/cathodic current collector-protecting layer coated with a cathodic catalyst/electrolyte membrane/anodic current collector-protecting layer coated with an anodic catalyst/anodic current collector. Alternatively, an anodic catalyst layer 22 and a cathodic catalyst layer 24 may be separately formed on opposite sides of an electrolyte membrane 10, and then layers may be bonded to the catalyst layers 22, 24 under high temperature and high pressure conditions, in an order of cathodic current collector/cathodic current collector protecting layer/cathodic catalyst layer/electrolyte membrane/anodic catalyst layer/anodic current collector protecting layer/anodic current collector.

The catalyst slurry may have various compositions depending on whether the catalyst layer to be prepared is to be used for the anode or the cathode, and is obtained by using conventional catalyst compositions and preparation methods.

The current collector 36, 38 that is formed on the current collector-protecting layer 32, 34 in an embodiment of the present invention may comprise a transition metal or a conductive polymer material that has an electrical conductivity of 1 S/cm or greater. As non-limiting examples, the transition metal may be gold (Au), silver (Ag), aluminum (Al), nickel (Ni), copper (Cu), platinum (Pt), titanium (Ti), manganese (Mn), zinc (Zn), iron (Fe), tin (Sn), or an alloy of these metals. As non-limiting examples, the conductive polymer material may be polyaniline, polypyrrole, polythiophene, or a mixture thereof.

Formation of the current collector 36, 38 may be performed by directly forming the current collector 36, 38 on the current collector-protecting layer 32, 34, or separately preparing the current collector 36, 38 and then bonding the current collector 36, 38 to the current collector-protecting layer 32, 34. The method of directly forming the current collector 36, 38 on the current collector-protecting layer 32, 34 may be performed through sputtering, chemical vapor deposition, electrodeposition, or the like, while the method of separately preparing the current collector 36, 38 and then bonding the current collector 36, 38 to the current collector-protecting layer 32, 34 may be performed by forming the current collector 36, 38 in the form of a metal mesh, or a conductive metal film supported by a frame of a non-conductive polymer film, using a flexible printed circuit board (FPCB) technique, for example.

To form the fuel diffusion layer 42, 44 on the current collector 36, 38, a fuel diffusion layer unit can be prepared by forming the fuel diffusion layer 42, 44 on a support layer which supports the fuel diffusion layer 42, 44, as described for the preparation of the catalyst layer 22, 24, and then sintering the fuel diffusion layer unit, or by preparing a slurry containing desired materials and then forming the fuel diffusion layer 42, 44 on a support layer 52, 54 through tape casting, spraying or screen printing. However, the present invention is not limited thereto.

Since the fuel diffusion layer 42, 44 is disposed on the current collector 36, 38, the fuel diffusion layer 42, 44 can comprise not only an electrically conductive material, but also a non-conductive material. For example, the fuel diffusion layer 42, 44 may entirely comprise non-conductive material.

As non-limiting examples, the electrically conductive material may include at least one material selected from the group consisting of powdered carbon, graphite, carbon black, acetylene black, activated carbon, carbon paper, carbon cloth, carbon nanotube, carbon nanofiber, carbon nanowire, carbon nanohorn, carbon nanoring and fullerene (C₆₀).

As non-limiting examples, the non-conductive material can be a hydrophobic material or a hydrophilic material. The hydrophobic material may be a polyethylene resin, a polystyrene resin, a fluorine based polymer resin, a polypropylene resin, a polymethyl methacrylate resin, a polyimide resin, a polyamide resin, a polyethylene terephthalate resin, or a mixture thereof, but is not limited thereto.

The hydrophilic material may be a polymer resin having a hydroxyl group, a carboxyl group, an amine group or a sulfone group at at least one terminal, and may be a polyvinyl alcohol resin, a cellulose-based polymer resin, a polyvinylamine resin, a polyethylene oxide resin, a polyethylene glycol resin, a nylon-based polymer resin, a polyacrylate resin, a polyester resin, a polyvinylpyrrolidone resin, an ethylene vinyl acetate-based polymer resin, or a mixture thereof, but is not limited thereto.

The fuel diffusion layer 42, 44 may further comprise a hydrous material for smooth supply of moisture. As non-limiting examples, the hydrous material may be a polymer resin having a hydroxyl group, a carboxyl group, an amine group or a sulfone group at at least one terminal, a polyvinyl alcohol resin, a cellulose-based polymer resin, a polyvinylamine resin, a polyethylene oxide resin, a polyethylene glycol resin, a nylon-based polymer resin, a polyacrylate resin, a polyester resin, a polyvinylpyrrolidone resin, an ethylene vinyl acetate-based resin, a metal oxide such as Al₂O₃, ZrO₂ or TiO₂, SiO₂, or a mixture thereof.

Furthermore, it may be advantageous that the fuel diffusion layer 42, 44 be porous to provide a smooth supply of an oxidizing agent such as air.

For the binding of such conductive or non-conductive materials, a binder can be used, such as, for example, a polymeric material such as polytetrafluoroethylene (PTFE), polyvinylidene fluoride (PVdF), fluorinated ethylene propylene (FEP), polyvinyl alcohol (PVA), polyacrylonitrile, a phenolic resin, cellulose acetate, or a mixture thereof, but the binder is not limited thereto.

The membrane electrode assembly according to aspects of the present invention can further include support layers 52, 54, respectively, on the anodic fuel diffusion layer 42 and the cathodic fuel diffusion layer 44.

As explained above, since the fuel diffusion layer 42, 44 is formed on the current collector 36, 38, the support layer 52, 54 supporting the fuel diffusion layer 42, 44 is not required to be electrically conductive. Thus, the support layer 52, 54 may be an electrically conductive material, a non-conductive material, or a mixture thereof.

Accordingly, the support layer 52, 54 may be hydrophobic, hydrophilic, porous or hydrous, as in the case of the fuel diffusion layer 42, 44.

The support layer 52, 54 may comprise a conductive material such as a metal or a carbonaceous material, as in the case of the fuel diffusion layer 42, 44, or may comprise a ceramic material, since conductivity is not a required property.

As non-limiting examples, the carbonaceous material may be carbon fiber, carbon paper, carbon cloth, carbon nanotube, carbon nanofiber, carbon nanohorn, carbon nanoring, carbon black, graphite, fullerene, activated carbon, acetylene black, or the like.

As non-limiting examples, the ceramic material may be a metal oxide such as alumina, tungsten oxide, nickel oxide, vanadium oxide, zirconia or titania; a silica compound such as zeolite; a clay such as montmorillonite, bentonite or mullite; silicon carbide; cordierite; or the like, but is not limited thereto.

The support layer 52, 54 may be formed by laminating a plurality of layers, each having one of the properties described above, or the support layer may be a single layer exhibiting two or more of the properties described above at the same time.

A fuel cell according to an embodiment of the present invention may be any one of a wide range of fuel cell types, including a proton exchange membrane fuel cell (PEMFC), a direct methanol fuel cell (DMFC), or a phosphoric acid fuel cell (PAFC). A fuel cell according to an embodiment of the present invention is particularly advantageous as a PEMFC or a DMFC.

The manufacturing of the fuel cell can be performed using any conventional method that is known in various literatures, and thus, a detailed explanation of the production method will not be given here.

According to embodiments of the present invention, the electrical resistance can be minimized by having a current collector formed between a catalyst layer and a fuel diffusion layer in each of the electrodes to shorten the electron transfer distance. Electrical resistance that may occur due to poor contact between the current collector and the catalyst layer can be minimized by including an electrically conductive current collector-protecting layer formed between the current collector and the catalyst layer, and the current generated at the catalyst layer can be collected at the current collector without passing through the fuel diffusion layer such that the electrical resistance can be minimized.

In addition, the formation of the fuel diffusion layer on the current collector allows the fuel diffusion layer to be formed of a wide range of materials, including conductive materials and non-conductive materials.

As a result, a fuel cell that can stably realize constant performance for a prolonged period of time, and which has excellent efficiency due to low electrical resistance, can be obtained.

Hereinafter, aspects of the present invention will be described in more detail with reference to the following Examples. However, these Examples are included for illustrative purposes only, and are not intended to limit the scope of the present invention.

### EXAMPLE 1

### Preparation of Anodic Catalyst Layer

0.2 g of Pt—Ru powder and 0.6 g of deionized water were mixed with a stirrer so that the deionized water penetrated between the particles of the Pt—Ru powder. 0.2 g of isopropyl alcohol (IPA) was added to the result, and after mechanical stirring, 0.2 g of deionized water and 0.706 g of a 5 wt % NAFION (DuPont) solution were added to the resulting mixture. The final mixture was stirred with an ultrasonic shaker for about 100 minutes to yield a slurry for the formation of an anodic catalyst layer.

Here, the density of Pt—Ru catalyst supported on the anode was 8 mg/cm².

The slurry for the formation of anodic catalyst layer was coated by spray coating onto a sheet of carbon paper, Toray 30 (Toray Industries, Inc.), having a thickness of 100 μm, which was to be used as a current collector-protecting layer, and was dried. Thus, an anodic catalyst layer was formed on a current collector-protecting layer.

### Preparation of Cathodic Catalyst Layer

A slurry for the formation of the cathodic catalyst layer was formed in the same manner as the slurry for the formation of the anodic catalyst layer, except that initially, 0.24 g of Pt powder and 0.3 g of deionized water were mixed such that the deionized water sufficiently penetrated between the particles of the Pt powder.

Here, the density of Pt catalyst supported on the cathode was 8 mg/cm².

The slurry for the formation of cathodic catalyst layer was coated by spray coating onto a sheet of carbon paper, TORAY 30 (Toray Industries, Inc.), having a thickness of 100 μm, which was to be used as a current collector-protecting layer, and was dried. Thus, a cathodic catalyst layer was formed on a current collector-protecting layer.

### Preparation of Diffusion Layer

7 g of silica (SiO₂) and 3 g of PVdF were mixed in 20 ml of acetone and sufficiently dispersed by stirring for 60 minutes. The resulting dispersion (Dispersion 1) was spray-coated onto 300 μm-thick SGL carbon paper (SGL Carbon Group), and then dried to form an anodic diffusion layer on an anodic support layer. The density of nanosilica contained in the anodic diffusion layer was 1 mg/cm².

In addition, 7 g of ordered mesoporous silica (OMS) and 3 g of PVdF were mixed in 20 ml of acetone and sufficiently dispersed by stirring for 60 minutes. The resulting dispersion (Dispersion 2) was spray-coated onto 300 μm-thick carbon paper containing 40 wt % of PTFE, (TORAY 090) (Toray Industries, Inc.), and then dried to form a cathodic diffusion layer on a cathodic support layer. The density of OMS contained in the cathodic support layer was 1 mg/cm².

### Production of Fuel Cell

The anodic catalyst layer coated with the current collector-protecting layer and the cathodic catalyst layer coated with the current collector-protecting layer as prepared above were respectively laminated on opposite sides of a NAFION 112 electrolyte membrane. A flexible printed circuit board (FPCB) current collector having a nickel metal mesh formed on a polyimide film, and the diffusion layer having the support layer laminated thereon were sequentially laminated on both sides of the previously prepared laminate, and the entire assembly was hot pressed to obtain a membrane electrode assembly. The hot pressing was performed at 125° C. under a pressure of 1 ton for 1 minute, and under a pressure of 2.2 tons for 3 minutes.

The membrane electrode assembly obtained had the following structure:

Anodic support layer/anodic diffusion layer/anodic current collector/anodic current collector-protecting layer/anodic catalyst layer/electrolyte membrane/cathodic catalyst layer/cathodic current collector-protecting layer/cathodic current collector/cathodic diffusion layer/cathodic support layer.

### EXAMPLE 2

A membrane electrode assembly was produced in the same manner as in Example 1, except that a NAFION 115 membrane was used as the electrolyte membrane.

### COMPARATIVE EXAMPLE 1

A Pt—Ru slurry for an anodic catalyst layer was spray-coated onto a NAFION 112 electrolyte membrane and dried in the same manner as described in the previous Examples, to form an anodic catalyst layer. A Pt slurry for the formation of cathodic catalyst layer was spray-coated on the other side of the NAFION 112 electrolyte membrane and dried in the same manner as described in the previous Examples, to form a cathodic catalyst layer.

A dispersion was prepared by sufficiently dispersing 7 g of powdered carbon and 3 g of PTFE in 20 ml of isopropyl alcohol by stirring for 60 minutes, and was spray-coated onto the anodic catalyst layer and the cathodic catalyst layer, respectively. Then, the spray-coated catalyst layers were sintered in an oven at 360° C. for 40 minutes to form an anodic diffusion layer and a cathodic diffusion layer. Subsequently, as support layers, 300 μm-thick carbon paper (Toray Industries, Inc.) was disposed on the anodic diffusion layer, and 300 μm-thick carbon paper (Toray Industries, Inc.) containing 20 wt % of PTFE was disposed on the cathodic diffusion layer. Nickel mesh current collectors were disposed on the respective support layers.

The obtained membrane electrode assembly had the following structure:

Anodic current collector/anodic support layer/anodic diffusion layer/anodic catalyst layer/electrolyte membrane/cathodic catalyst layer/cathodic diffusion layer/cathodic support layer/cathodic current collector.

### COMPARATIVE EXAMPLE 2

A membrane electrode assembly was produced in the same manner as in Comparative Example 1, except that a NAFION 115 membrane was used as the electrolyte membrane.

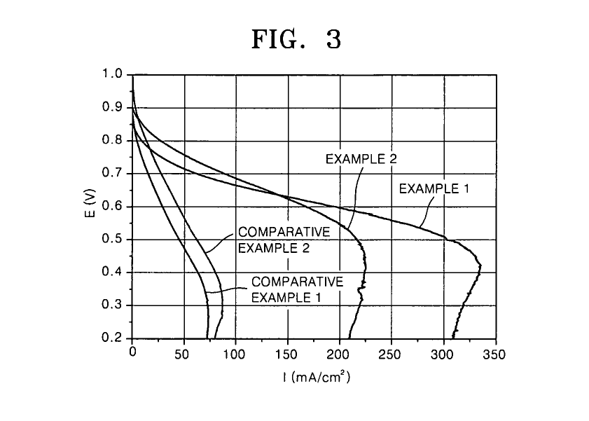

The membrane electrode assemblies produced as described above were used to produce direct methanol fuel cells, and the performance of the fuel cells was tested by supplying a 3 M methanol solution to the anode, and supplying air to the cathode in a passive manner. Changes in the cell potential (or cell voltage) with current density were examined. The results are presented in FIG. 3, in which I represents current density and E represents cell voltage.

It can be seen from FIG. 3 that the performance of the fuel cells produced in Examples 1 and 2 according to the fuel cell structure of an embodiment of the present invention was significantly improved by 200 to 500% over the fuel cells produced in Comparative Examples 1 and 2 at an operating voltage between 0.3 V and 0.4 V. Without being bound to any particular theory, it is believed that the improvement may be attributed to the lower electrical resistance for the current flowing to the current collector, and to the current collector-protecting layers between the catalyst layers and the current collectors, which resulted in the prevention of corrosion of the current collector by the catalyst, thus improving the current characteristics.

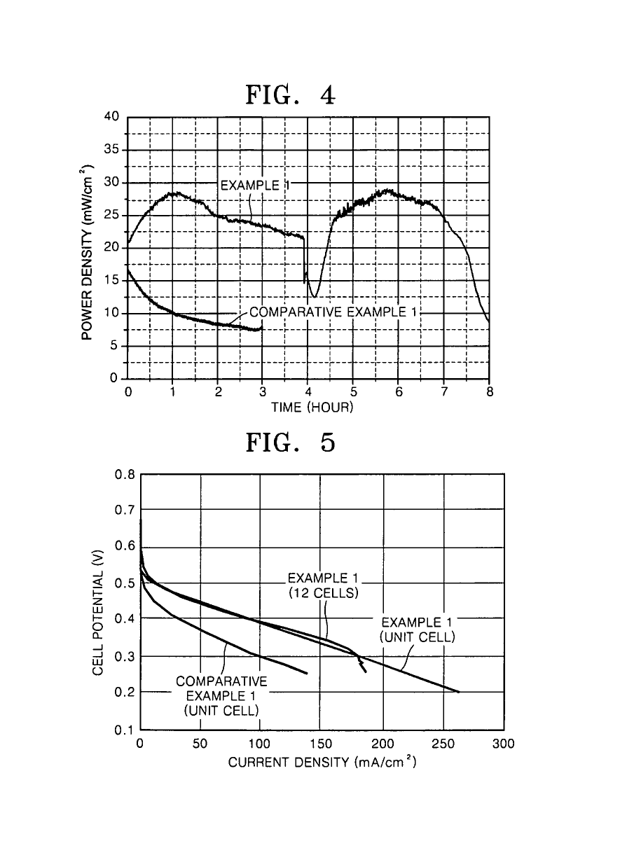

FIG. 4 shows the power density with respect to time for the fuel cells of Example 1 and Comparative Example 1 in order to provide a comparison of the lifetime characteristics of the two fuel cells. The fuel cell of Example 1 exhibited a better current density and a prolonged driving time upon fuel feeding relative to the fuel cell of Comparative Example 1.

The methanol concentration, water concentration and generated current were measured at each electrode and the fuel efficiency was calculated for the fuel cells of Examples 1 and 2, and Comparative Examples 1 and 2. A 0.3 M methanol solution was used as fuel and was supplied at a flow rate of 0.1 cc/min. Air was used as an oxidizing agent. The results are presented in the following Table 1. Here, the term fuel efficiency refers to the ratio of the fuel used to generate energy to the total fuel supplied.

TABLE 1

| | Fuel Efficiency (%) |
|---|---|
| Example 1 | 80.93 |
| Example 2 | 58.82 |
| Comparative Example 1 | 11.51 |
| Comparative Example 2 | 29.11 |

As shown in Table 1, the fuel efficiencies obtained from the fuel cells of Example 1 and Example 2 exceeded 50%, and particularly, the fuel efficiency of the fuel cell of Example 1 was greater than 80%. On the other hand, the fuel efficiencies of the fuel cells of Comparative Example 1 and Comparative Example 2 were less than 30%. Therefore, the unit fuel cells adopting the membrane electrode assembly according to embodiments of the present invention showed superior fuel efficiencies. Without being bound to any particular theory, the improvement is believed to be largely attributable to the hydrous properties of the nanosilica and mesoporous silica used in Example 1 and Example 2, respectively.

### EXAMPLE 3

Twelve unit fuel cells of Example 1 were connected in series, and their performance was compared with that of a single unit fuel cell of Example 1. The cell voltage of the fuel cell of Example 3 was divided by 12 to calculate the cell voltage of one of the unit fuel cells included in the fuel cell of Example 3.

Referring to FIG. 5, the performance of the unit fuel cell of Example 1 and that of the 12 unit fuel cells were found to be similar, and both had much better cell performance than the unit fuel cell of Comparative Example 1.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A membrane electrode assembly comprising:
an electrolyte membrane;
an anodic catalyst layer disposed on one side of the electrolyte membrane;
a cathodic catalyst layer disposed on the opposite side of the electrolyte membrane;
an anodic current collector-protecting layer disposed on the anodic catalyst layer;
a cathodic current collector-protecting layer disposed on the cathodic catalyst layer;
an anodic current collector disposed on the anodic current collector-protecting layer;
a cathodic current collector disposed on the cathodic current collector-protecting layer;
an anodic diffusion layer disposed on the anodic current collector; and
a cathodic diffusion layer disposed on the cathodic current collector.

2. The membrane electrode assembly of claim 1, wherein the current collector-protecting layer comprises an electrically conductive material.

3. The membrane electrode assembly of claim 1, wherein the current collector-protecting layer comprises at least one material selected from the group consisting of a carbonaceous material, an electrically conductive polymer and a conductive metal.

4. The membrane electrode assembly of claim 3, wherein the current collector-protecting layer comprises at least one carbonaceous material selected from the group consisting of powdered carbon, graphite, carbon black, acetylene black, activated carbon, carbon nanotube, carbon nanofiber, carbon nanowire, carbon nanohorn, carbon nanoring and fullerene (C₆₀).

5. The membrane electrode assembly of claim 3, wherein the current collector-protecting layer comprises at least one electrically conductive polymer selected from the group consisting of polyaniline, polypyrrole and polythiophene.

6. The membrane electrode assembly of claim 3, wherein the current collector-protecting layer comprises a conductive metal that has a conductivity of 1 S/cm or greater.

7. The membrane electrode assembly of claim 6, wherein the conductive metal comprises at least one metal selected from the group consisting of gold (Au), silver (Ag), aluminum (Al), nickel (Ni), copper (Cu), platinum (Pt), titanium (Ti), manganese (Mn), zinc (Zn), iron (Fe), tin (Sn), and alloys thereof.

8. The membrane electrode assembly of claim 1, wherein the current collector-protecting layer comprises a porous material.

9. The membrane electrode assembly of claim 8, wherein the current collector-protecting layer has a porosity of 10% to 90%.

10. The membrane electrode assembly of claim 1, wherein the current collector-protecting layer has a thickness of 10 μm to 500 μm.

11. The membrane electrode assembly of claim 1, wherein the current collector comprises gold (Au), silver (Ag), aluminum (Al), nickel (Ni), copper (Cu), platinum (Pt), titanium (Ti), manganese (Mn), zinc (Zn), iron (Fe), tin (Sn), or an alloy thereof.

12. The membrane electrode assembly of claim 1, wherein the current collector is a metal mesh.

13. The membrane electrode assembly of claim 1, wherein the current collector is a flexible printed circuit board comprising:
a non conductive polymer film; and
a conductive metal mesh formed on the non-conductive polymer film.

14. The membrane electrode assembly of claim 1, wherein the diffusion layer comprises an electrically conductive material, a non-conductive material, or a mixture thereof.

15. The membrane electrode assembly of claim 14, wherein the electrically conductive material is a carbonaceous material.

16. The membrane electrode assembly of claim 14, wherein the non-conductive material is a hydrophobic material, a hydrophilic material, a hydrous material, a porous material, or a mixture thereof.

17. The membrane electrode assembly of claim 16, wherein the hydrophobic material is a polyethylene resin, a polystyrene resin, a fluoropolymer resin, a polypropylene resin, a polymethyl methacrylate resin, a polyimide resin, a polyamide resin, a polyethylene terephthalate resin, or a mixture thereof.

18. The membrane electrode assembly of claim 16, wherein the hydrophilic material is a polymer resin containing a hydroxyl group, a carboxyl group, an amine group or a sulfone group at at least one terminal, a polyvinyl alcohol resin, a cellulose-based polymer resin, a polyvinylamine resin, a polyethylene oxide resin, a polyethylene glycol resin, a nylon-based polymer resin, a polyacrylate resin, a polyester resin, a polyvinylpyrrolidone resin, an ethylene vinyl acetate-based resin, or a mixture thereof.

19. The membrane electrode assembly of claim 16, wherein the hydrous material is a polymer resin containing a hydroxyl group, a carboxyl group, an amine group or a sulfone group at at least one terminal, a polyvinyl alcohol resin, a cellulose-based polymer resin, a polyvinylamine resin, a polyethylene oxide resin, a polyethylene glycol resin, a nylon-based polymer resin, a polyacrylate resin, a polyester resin, a polyvinylpyrrolidone resin, an ethylene vinyl acetate-based resin, Al₂O₃, ZrO₂, TiO₂, SiO₂, or a mixture thereof.

20. The membrane electrode assembly of claim 1, further comprising support layers on the anodic diffusion layer and the cathodic diffusion layer, respectively.

21. The membrane electrode assembly of claim 20, wherein the support layer comprises a non-conductive material, a conductive material, or a mixture thereof.

22. The membrane electrode assembly of claim 21, wherein the support layer comprises a metal, a ceramic material, or a carbonaceous material.

23. The membrane electrode assembly of claim 22, wherein the support layer comprises a carbonaceous material selected from the group consisting of carbon fiber, carbon paper, carbon cloth, carbon nanotube, carbon nanofiber, carbon nanohorn, carbon nanoring, carbon black, graphite, fullerene, activated carbon, and acetylene black.

24. The membrane electrode assembly of claim 22, wherein the support layer comprises a ceramic material selected from the group consisting of a metal oxide, a silica based compound, a clay, silicon carbide and cordierite.

25. A fuel cell comprising the membrane electrode assembly of claim 1.

26. An electrode of a membrane electrode assembly comprising:
a catalyst layer;
a current collector protecting layer;
a current collector; and
a fuel diffusion layer,
wherein the current collector-protecting layer is between the current collector and the catalyst layer, and
wherein the current collector and current collector-protecting layer are between the diffusion layer and the catalyst layer.
